(19) United States
(12) Patent Application Publication
(10) Pub. No.: US 2007/0095392 A1
(43) Pub. Date: May 3, 2007

(54) Accident pressure relief system for automobile gaseous fuel tank

(76) Inventor: David Robert Billings, Burlington (CA)

Correspondence Address: DAVID ROBERT BILLINGS, 2302 WAGNER CRESCENT, BURLINGTON, ON, L7R-1S9, CA

(21) Appl. No.: 11/585,969

(22) Filed: Oct. 25, 2006

Related U.S. Application Data
(60) Provisional application No. 60/730,667, filed on Oct. 28, 2005.

(51) Int. Cl. F16K 17/36

(52) U.S. Cl. 137/39

(57) ABSTRACT

A modified compressed gas cylinder for use in hydrogen powered vehicles which lessens the explosive danger from accidental collisions by using an electronic signal from the airbag system to open a normally closed pressure relief valve. The released hydrogen gas releases through a vent pipe which exits either through the fill pipe area or through a vent in the top of the automobile. A whistle on the vent pipe informs drivers, passengers and bystanders if the pressure relief valve is allowing the escape of hydrogen gas. A mechanical lever maintains the open position of the pressure relief valve once the airbag signal is received until the driver triggers a mechanical latch similar to a trunk release which returns the pressure relief valve to its normally closed position. The pressure relief valve can also open if for some reason the internal pressure of the hydrogen storage tank exceeds the appropriate safety level due to excess density and or temperature rise.

### BACKGROUND OF THE INVENTION

One hindrance to the wide scale adoption of hydrogen and natural gas for the fueling of automobiles is the explosive nature of these fuels and the possibility of catastrophic explosion in the instance of an automobile accident. If the accident results in physical damage to the compressed gas cylinder, the instantaneous pressure of the cylinder at time of impact can rupture the tank. This results in two possible threats. The uncontrolled release of gas can cause a physical force to be exerted on the automobile, much like the force of letting the air out of a balloon. Also, releasing the entire contents of the tanks fuel into the surrounding atmosphere can cause the fuel air ratio of the surrounding area to be within the explosive limits. Fuels are only explosive when their concentration in the air is above the lower explosive limit and below the lower explosive limit. Uncontrolled emission of the entire compressed gas tank into the surrounding air can result in a large cloud of gas with concentrations in the explosive range. If a spark of some kind occurs, which is quite likely in the case of an accident, the result is a large gas-oxygen cloud producing an immense explosion. By having a pressure relief valve already venting when the compressed gas cylinder is damaged the explosive force of the accident will be mitigated since the momentary extreme pressure of the cylinder at the moment of collision will be reduced.

While pressure relief valves are quite common for stationary cylinders of compressed gas none of these are known to have emergency pressure relief valve which release gas during the instance of accidental impact. However, automobiles have for many years had emergency signaling systems which operate the inflation of air bags for passenger safety during accidental collision.

### SUMMARY OF THE INVENTION

The invention uses the air bag sensor system of an automobile with gaseous fuel to vent the compressed gas cylinder in the instance of a collision to reduce the risk of explosion.

### A BRIEF DESCRIPTION OF THE DRAWINGS

FIG. 1 shows a common pressure relief valve with a test lever.

FIG. 2 is a sectional view of the pressure relief control housing for venting pressure during an automobile's collision through a test lever in its resting position.

FIG. 3 is a sectional view of the system when the collision signal has opened the vent.

FIG. 4 is a sectional view of the system as the release solenoid has removed the lever from the notch to allow the system to return to the state shown in FIG. 2.

### PREFERRED EMBODIMENT OF THE INVENTION

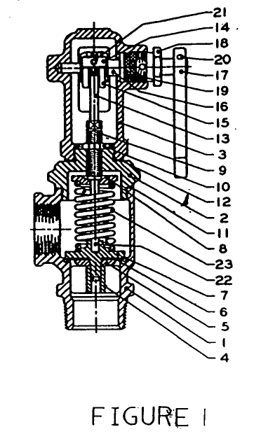

A typical pressure relief valve is shown in FIG. 1. This pressure relief valve relieves gas when the pressure in the tank exceeds the force exerted by the spring (23) or when the test lever (17) is manually moved. When the internal pressure of the tank exceeds the spring (23) the disc holder (7) is moved allowing gas to escape.

When the test lever (17) is moved the cam (15) is rotated to force a displacement of the valve mechanisms stem (13) which moves the disc holder (7) allowing the gas to escape.

In the preferred embodiment of this invention a control housing mechanism (24) which will operate the test lever (17). The control housing mechanism (24) contains two solenoids: the pressure relief lever stem solenoid (30) and the release stem solenoid. (31). The pressure relief lever stem solenoid (30) is activated by the same electronic signal which operates the air bag system of the automobile in the instance of an accidental impact. This signal is delivered through the pressure relief signal wires (35). When this signal occurs the pressure relief lever stem solenoid motivates the pressure relief lever stem (25) and the pressure relief lever disc (27) to overcome the natural position of the pressure relief lever spring (26) and move the test lever (17) to a position which will rotate the cam (15) so that gas pressure is release through the pressure relief valve.

FIG. 2 shows the control housing mechanism (24) at the rest position with no signals active. FIG. 3 shows the control housing mechanism (24) as the collision signal has activated the pressure relief lever stem solenoid (30) to release gas from the pressure relief valve.

The release lever (33) is motivated by the natural position of the release spring (29) into the notch (40) as the pressure relief lever stem (25) moves. When the signal caused by the accident is removed the release lever (33) holds the pressure relief lever stem (25) in the open position. This is important in case the electrical system of the car is damaged during the accident in which case the open signal could be terminated before a second aspect of the collision damages the fuel tank. The release stem (28) is motivated by the natural position of the release spring (29) to keep the release lever (33) in the notch (40) until a timed signal from the air bag system comes over the release signal wires (34), motivating the release disc (41) and the release stem solenoid (31) to overcome the release spring (29) and remove the release lever (33) from the notch (40) so that the pressure relief lever spring (26) can return to its natural position and the test lever (17) can close the pressure relief valve.

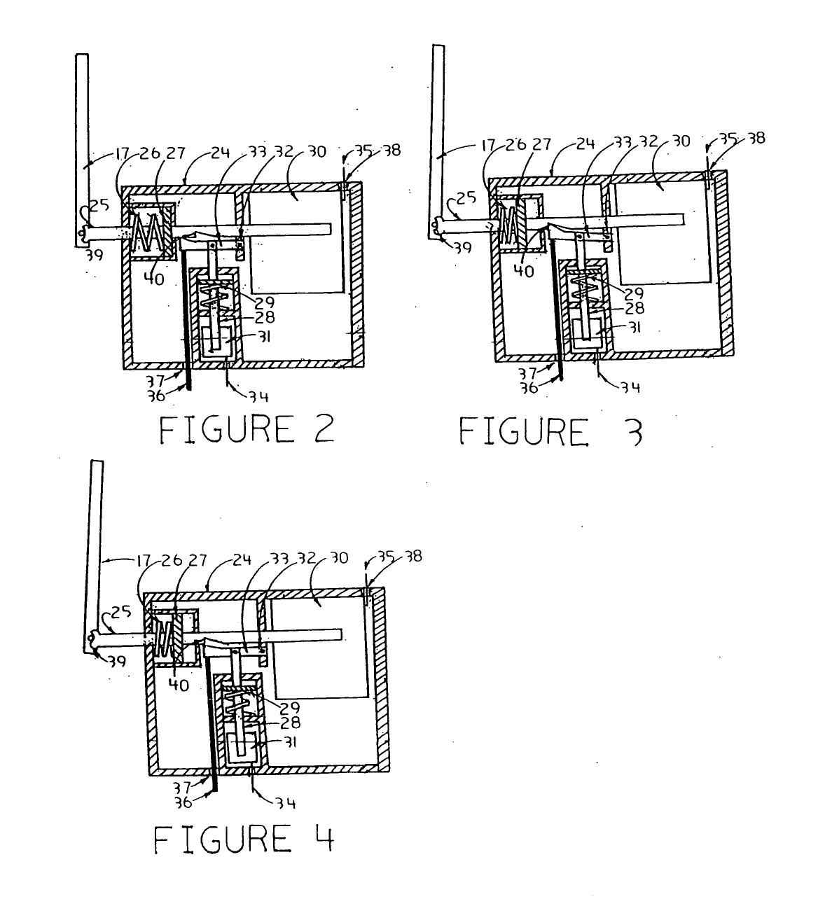

FIG. 4 shows the control housing mechanism (24) at the moment when either the manual release cable (36) or the release stem solenoid (31) has pulled the release lever (33) free of the notch (40). When the pressure relief lever spring (26) returns to its natural position the control mechanism housing (24) will look like FIG. 2.

The time delay between the collision signal and the release signal should be a period of time which will cover the period of time of a typical collision but not so long that excess gas will be released from a minor collision. Five seconds is a suggested time delay. In the case of a multiple car pile up or other lengthy collision the air bag signal may send multiple pressure relief signals to the pressure relief signal wires to trigger multiple openings of the pressure relief valve even though the air bags will only inflate once. In case the automobiles electrical system is damaged after the collision signal is sent out the air bag system may become unable to send out the time delayed release signal.

In this instance the pressure relief valve will continue to relieve gas pressure until a manual release lever on the cars dashboard, much like a hood release lever is activated. Pulling this lever will motivate the manual release cable (36) to move through the manual release cable washer (37), overcoming the natural position of the release spring (29) for the moment required so that the release lever (33) is pulled from the notch (40), allowing the pressure relief spring (29) to regain its original position so that the test lever (17) closes the pressure relief from the pressure relief valve.

It is recommended that the outlet from the pressure relief valve be directed as high vertically as style will allow, perhaps through a vent close to the filling pipe. This will direct the lighter than air gases as far from the vehicle as possible. It is hoped that the volume will be small and the area where the concentration is in the explosive range will be above the vehicle where the probability that it will ignite will be small and the location of any possible ignition will in most instances mitigate the damages created.

The pressure relief valve, the test lever (17) and the pressure relief control housing (24) should be on the side of the compressed gas tank where they are accessible for service when the car is on a hoist. It should be possible to move the test lever (17) to open the pressure relief valve by hand for maintenance purposes. It should also be possible to create a pressure relief signal, which triggers the accompanying delayed release signal, from the dashboard either by computer codes or a button. This will allow for regular inspection of the pressure relief system by either mechanic, owner or both.

A non sparking whistle device should be placed at the outlet of the pressure relief valve. This will notify all in the area about a pressure relief which occurs for any reason. During maintenance checks it will notify the mechanic or the owner as to when pressure is being relieved. In the case of an accident it will notify the driver that the gas is being relieved for the determined time delay period. Or if the electrical system of the automobile has been damaged by the accident after the collision system has been generated but before the release signal has been generated, the whistle noise will notify the driver to pull the manual release lever on the cars dashboard.

An alternate embodiment of the invention would be a one time use system whereby the air bag collision system would signal a miniature air bag attached to a plug on the side of the compressed gas cylinder. The miniature air bag would remove the plug from the wall of the compressed gas cylinder to vent the tank in a controlled manner. However, the other embodiment is preferred since it is reusable and offers more precise control.

If the threat of vandalism to the cars fuel supply is a design concern a few modifications may be utilized. A lock, a simple as a padlock operated by the cars ignition key, may be used to join the test lever (17) and the test lever pin grip (39). These two items would be manufactured so that each is appended with a metal tab with a hole in it so that the two can be locked together but unlocked for test and maintenance purposes. Also, a vented metal cage may be manufactured to house both the pressure relief control housing (24) and pressure relief valve together. This metal cage will be secured by a lock mechanism which is accessed by the car ignition key. It should be vented at the top to prevent accumulation of leaked fuel. To prevent the fuel being vented by multiple tests of the system which have been initiated by the dashboard or computer code, the cars electrical system can be programmed to impose a mandatory time delay, say two minutes, between tests. This will allow for maintenance procedures, but, when coupled with the whistle mechanism on the vent pipe, will deter vandalism.

What I claim as my invention is:

1. A pressure relief system comprising:
a compressed gas cylinder
a pressure relief valve on said compressed gas cylinder,
a sensor which detects accidental impact, and,
a means of communication between said sensor which detects accidental impact and said pressure relief valve on said compressed gas cylinder.

2. A latching system to control the pressure relief valve of claim 1, using a solenoid to open the pressure relief valve.

3. A latching system as in claim 2 where the pressure relief valve is maintained in the open position despite a lack of electrical signal to the solenoid by a lever which catches a notch in the pressure relief lever stem. A separate solenoid overcomes a spring which holds this lever in the notch when it is desired that the pressure relief valve return to its normally closed position.

4. A pressure relief system as in claim 1 where a lock joins the test lever and the pressure relief lever stem.

5. A pressure relief system as in claim 1 where the pressure relief valve and the pressure relief control housing are housed in a locked and vented cage.

6. A pressure relief system as in claim 1 which is equipped with a manually actuated lever to close an open pressure relief valve.

7. A pressure relief system as in claim 1 wherein the means of communication between sensor and pressure relief valve is electrical wiring.

8. A pressure relief system as in claim 1 wherein the means of communication between sensor and pressure relief valve is hydraulic or pneumatic.
